(19) United States
(12) Patent Application Publication
(10) Pub. No.: US 2026/0301619 A1
(43) Pub. Date: Oct. 1, 2026

(54) DISPLAY DEVICE AND DISPLAY METHOD

(71) Applicant: AUO Corporation, Hsinchu City (TW)

(72) Inventors: Po-Cheng LAI, Hsinchu City (TW); Wei-Jen CHEN, Hsinchu City (TW); Yi-Yo DAI, Hsinchu City (TW); Chia-Hao LIN, Hsinchu City (TW); Hong-Bin BU, Hsinchu City (TW); Li-Wei SHIH, Hsinchu City (TW)

(21) Appl. No.: 19/409,968

(22) Filed: Dec. 5, 2025

(30) Foreign Application Priority Data
Mar. 28, 2025 (TW) 114112211

(51) Int. Cl. G09G 3/00

(52) U.S. Cl. CPC G09G 3/006; G09G 2300/0452; G09G 2330/10; G09G 2330/12

(57) ABSTRACT

A display device and a display method are provided. The display device includes first light-emitting elements second light-emitting elements and third light-emitting elements. The display method includes: providing the display device; controlling a repair light-emitting element among the first light-emitting elements to emit light with a first brightness; controlling brightness-enhancing light-emitting elements among the first light-emitting elements to emit light with a second brightness, in which the repair light-emitting element is located on one row of a matrix, and the brightness-enhancing light-emitting elements are located on a first adjacent row of the matrix, and the second brightness is greater than the first brightness; and controlling brightness-reducing light-emitting elements among the first light-emitting elements to emit light with a third brightness, in which the brightness-reducing light-emitting elements are located on a second adjacent row of the matrix, and the third brightness is less than the second brightness.

### CROSS-REFERENCE TO RELATED APPLICATION

This application claims priority to Taiwan Application Serial Number 114112211, filed Mar. 28, 2025, which is herein incorporated by reference.

### BACKGROUND

### Field of Invention

The present disclosure relates to a display device and a display method, and more particularly to a display device and a display method applicable to the use of a repair light-emitting element.

### Description of Related Art

In recent years, display panels employing micro light-emitting diodes (micro LEDs) have become increasingly popular because micro LEDs offer advantages such as easy color adjustment, long emission lifetime, and freedom from image burn-in.

During a manufacturing process of a display device, when a micro LED within a pixel structure becomes defective, a repair process is performed to address the defective micro LED. For example, a new micro LED may be disposed to replace the defective one.

However, the display device after repair may produce a foreign-object sensation in the visual effect.

### SUMMARY

An object of the present disclosure is to provide a display device and a display method that overcome the aforementioned issue of the foreign-object sensation in the visual effect.

According to embodiments of the present disclosure, the display device includes first light-emitting element arrangement regions, second light-emitting element arrangement regions, third light-emitting element arrangement regions, first light-emitting elements, second light-emitting elements, and third light-emitting elements. The first light-emitting element arrangement regions correspond to a first color. The first light-emitting element arrangement regions include a plurality of predetermined chip positions and a plurality of adjacent repair chip positions. The second light-emitting element arrangement regions corresponds to a second color. The second light-emitting element arrangement regions include a plurality of predetermined chip positions and a plurality of adjacent repair chip positions. The third light-emitting element arrangement regions correspond to a third color. The third light-emitting element arrangement regions includes a plurality of predetermined chip positions and a plurality of adjacent repair chip positions. The first light-emitting elements correspond to the first color and disposed in the first light-emitting element arrangement regions. The second light-emitting elements correspond to the second color and disposed in the second light-emitting element arrangement regions. The third light-emitting elements correspond to the third color and disposed in the third light-emitting element arrangement regions. The predetermined chip positions and the repair chip positions of the first, second, and third light-emitting element arrangement regions are arranged in a matrix manner. The first light-emitting elements includes a repair light-emitting element disposed at the repair chip position of one of the first light-emitting element arrangement regions and defining an original-side region and an opposite-side region in the matrix, and the predetermined chip position of the one of the first light-emitting element arrangement regions is located in the original-side region, and the repair chip position of the one of the first light-emitting element arrangement regions is located in the opposite-side region. The first light-emitting elements further includes a plurality of brightness-enhancing light-emitting elements and a plurality of brightness-reducing light-emitting elements, and the repair light-emitting element is located on one row of the matrix, and the brightness-enhancing light-emitting elements are located on a first adjacent row of the matrix, and the brightness-reducing light-emitting elements are located on a second adjacent row of the matrix, and the first adjacent row is adjacent to the row of the matrix and located in the original-side region, and the second adjacent row is adjacent to the row of the matrix and located in the opposite-side region, and a brightness of the brightness-enhancing light-emitting elements is greater than that of the brightness-reducing light-emitting elements.

In some embodiments, a brightness of the repair light-emitting element is less than that of the brightness-reducing light-emitting elements.

In some embodiments, the first light-emitting elements further include a plurality of predetermined light-emitting elements disposed on the first adjacent row and the second adjacent row. In the first and second adjacent rows, the brightness-enhancing light-emitting elements and the brightness-reducing light-emitting elements are those among the first light-emitting elements that are located closer to the repair light-emitting element, and the predetermined light-emitting elements are located farther from the repair light-emitting element.

In some embodiments, the first color, the second color, and the third color are red, blue, and green, respectively.

In some embodiments, the first light-emitting element arrangement region is larger than the second and third light-emitting element arrangement regions.

In some embodiments, the first light-emitting elements, the second light-emitting elements and the third light-emitting elements are micro LEDs.

In some embodiments, the display device further includes a plurality of bonding pads located on the predetermined chip positions and the repair chip positions.

In some embodiments, the first light-emitting elements, the second light-emitting elements and the third light-emitting elements are arranged to from a strip-type pixel structure.

According to embodiments of the present disclosure, the display method includes: providing a display device; controlling a repair light-emitting element among the first light-emitting elements to emit light with a first brightness, in which the repair light-emitting element is disposed at a repair chip position of one of the first light-emitting element arrangement regions and defines an original-side region and an opposite-side region in the matrix, and a predetermined chip position of the one of the first light-emitting element arrangement regions is located in the original-side region, and the repair chip position of the one of the first light-emitting element arrangement regions is located in the opposite-side region; controlling a plurality of brightness-enhancing light-emitting elements among the first light-emitting elements to emit light with a second brightness, in which the repair light-emitting element is located on one row of the matrix, and the brightness-enhancing light-emitting elements are located on a first adjacent row of the matrix, and the first adjacent row is adjacent to the row of the matrix and located in the original-side region, and the second brightness is greater than the first brightness; and controlling a plurality of brightness-reducing light-emitting elements among the first light-emitting elements to emit light with a third brightness, in which the brightness-reducing light-emitting elements are located on a second adjacent row of the matrix, and the second adjacent row is adjacent to the row of the matrix and located in the opposite-side region, and the third brightness is less than the second brightness.

In some embodiments, the first brightness is less than the third brightness.

In some embodiments, the first light-emitting elements further includes a plurality of predetermined light-emitting elements disposed on the first adjacent row and the second adjacent row; in the first and second adjacent rows, the brightness-enhancing light-emitting elements and the brightness-reducing light-emitting elements are those among the first light-emitting elements that are located closer to the repair light-emitting element, and the predetermined light-emitting elements are located farther from the repair light-emitting element; and the display method further includes: controlling the predetermined light-emitting elements to emit light with a predetermined brightness, the predetermined brightness being smaller than the second brightness and greater than the third brightness.

In some embodiments, the first color, the second color, and the third color are red, blue, and green, respectively.

In some embodiments, the first light-emitting element arrangement region is larger than the second and third light-emitting element arrangement regions.

In some embodiments, the first light-emitting elements, the second light-emitting elements and the third light-emitting elements are micro LEDs.

In some embodiments, the first light-emitting elements, the second light-emitting elements and the third light-emitting elements are arranged to from a strip-type pixel structure.

### BRIEF DESCRIPTION OF THE DRAWINGS

Aspects of the present disclosure are best understood from the following description of implementations when read in conjunction with accompanying figures. Note that in accordance with standard practice in this industry, various features are not drawn to scale. In fact, dimensions of various features may be arbitrarily increased or reduced for clarity of discussion.

FIG. 1 is a schematic structural diagram of a display device according to an embodiment of the present disclosure;

FIG. 2 is a schematic diagram of a panel pixel structure without light-emitting elements according to an embodiment of the present disclosure;

FIG. 3 is a schematic diagram of a panel pixel structure with light-emitting elements according to an embodiment of the present disclosure;

FIG. 4 is a schematic diagram of a panel pixel structure according to an embodiment of the present disclosure;

FIG. 5 is a schematic flow diagram of a display method according to an embodiment of the present disclosure;

FIG. 6 is a schematic diagram of a panel pixel structure without light-emitting elements according to an embodiment of the present disclosure; and

FIG. 7 is a schematic diagram of a panel pixel structure with light-emitting elements according to an embodiment of the present disclosure.

### DETAILED DESCRIPTION

The following description provides detailed explanations of the embodiments of the present disclosure with reference to the accompanying drawings. However, the disclosed embodiments are not intended to limit the scope of the present disclosure. The description of the structure and operation is not intended to restrict the order of execution. Any structure formed by recombining elements that achieves equivalent effects shall fall within the scope of the present disclosure. Furthermore, the drawings are provided for illustrative purposes only and are not drawn to scale.

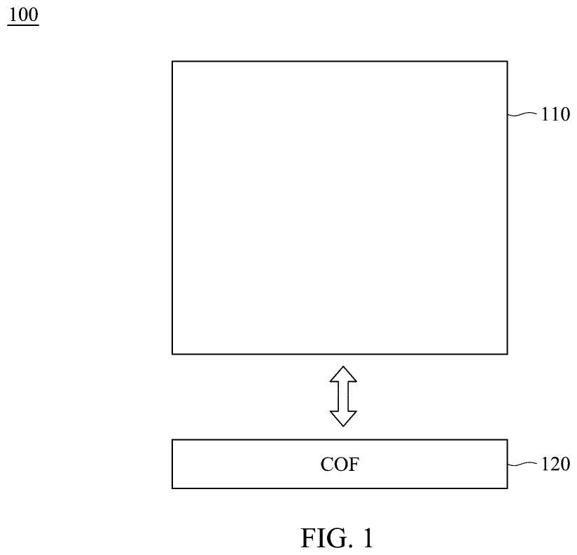

Referring to FIG. 1, FIG. 1 is a schematic structural diagram of a display device 100 according to an embodiment of the present disclosure. The display device 100 includes a panel 110 and a connection device 120. The connection device 120 is used to connect the panel 110 to external electronic components, such as a driver. In this embodiment, the connection device 120 adopts a chip-on-film (COF) technology. However, the embodiments of the present disclosure are not limited thereto.

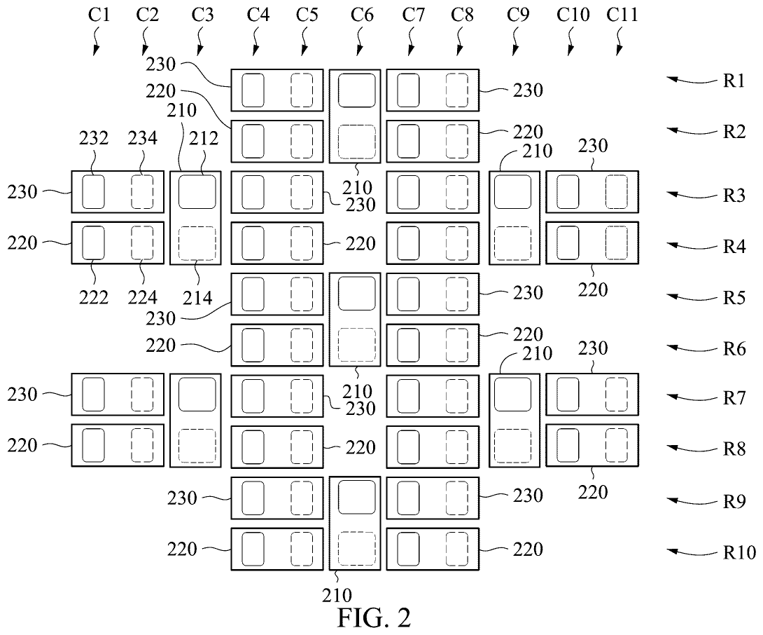

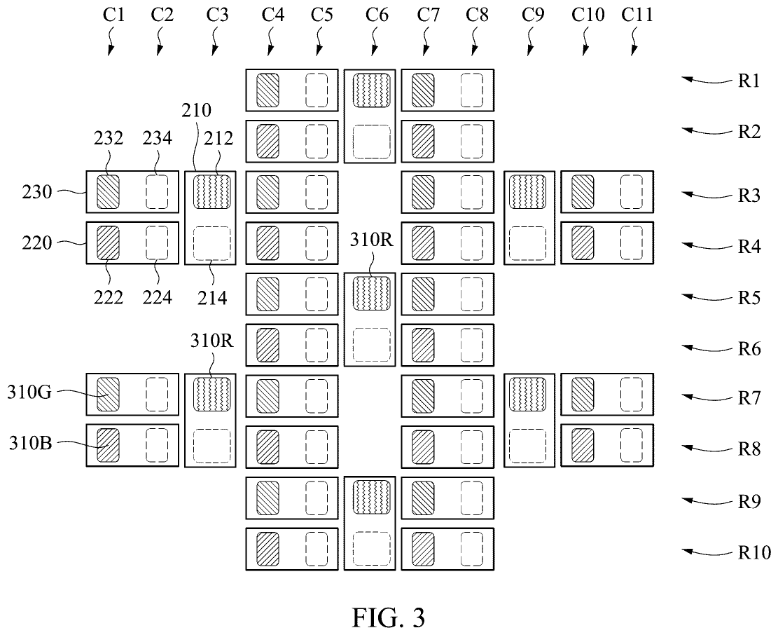

Referring to FIGS. 2 and 3, FIG. 2 is a schematic diagram of a panel pixel structure without light-emitting elements according to an embodiment of the present disclosure, and FIG. 3 is a schematic diagram of a panel pixel structure with light-emitting elements according to an embodiment of the present disclosure. As shown in FIG. 2, in this embodiment, the panel includes a first light-emitting element arrangement region 210, a second light-emitting element arrangement region 220, and a third light-emitting element arrangement region 230. In this embodiment, the first light-emitting element arrangement region 210 is larger than the second and third light-emitting element arrangement regions 220 and 230. However, the embodiments of the present disclosure are not limited thereto. In other embodiments of the present disclosure, the first, second, and third light-emitting element arrangement regions 210, 220, and 230 may have the same size.

The first light-emitting element arrangement regions 210 correspond to a first color, such as red. In other words, the first light-emitting element arrangement regions 210 are configured for red light-emitting elements. The first light-emitting element arrangement region 210 includes a predetermined chip position 212 and a repair chip position 214. Generally, the red light-emitting element is initially disposed at the predetermined chip position 212. When a red light-emitting element becomes defective, the user first performs an in-situ repair process to repair the defective red light-emitting element at the predetermined chip position 212. If the in-situ repair process fails, an ex-situ repair process is performed at the repair chip position 214.

The second light-emitting element arrangement regions 220 correspond to a second color, such as green. In other words, the second light-emitting element arrangement regions 220 are configured for green light-emitting elements. The second light-emitting element arrangement region 220 includes a predetermined chip position 222 and a repair chip position 224. Generally, the green light-emitting elements are initially disposed at the predetermined chip positions 222. When a green light-emitting element becomes defective, the user first performs an in-situ repair process to repair the defective green light-emitting element at the predetermined chip position 222. If the in-situ repair process fails, an ex-situ repair process is performed at the repair chip position 224.

The third light-emitting element arrangement regions 230 correspond to a third color, such as blue. In other words, the third light-emitting element arrangement regions 230 are configured for blue light-emitting elements. The third light-emitting element arrangement region 230 includes a predetermined chip position 232 and a repair chip position 234. Generally, the blue light-emitting elements are initially disposed at the predetermined chip position 232. When a blue light-emitting element becomes defective, the user first performs an in-situ repair process to repair the defective blue light-emitting element at the predetermined chip position 232. If the in-situ repair process fails, an ex-situ repair process is performed at the repair chip position 234.

As shown in FIG. 3, a first light-emitting element 310R is disposed at the predetermined chip position 212 of the first light-emitting element arrangement region 210; a second light-emitting element 310G is disposed at the predetermined chip position 232 of the second light-emitting element arrangement region 220; and a third light-emitting element 310B is disposed at the predetermined chip position 222 of the third light-emitting element arrangement region 230. In this embodiment, the first light-emitting element 310R, the second light-emitting element 310G, and the third light-emitting element 310B are red, green, and blue micro light-emitting diode (micro LED) elements, respectively. Both the predetermined chip positions and the repair chip positions are provided with bonding pads for bonding the micro LED elements.

In the embodiment of the present disclosure, the predetermined chip positions 212 and repair chip positions 214 of the first light-emitting element arrangement regions 210, the predetermined chip positions 222 and repair chip positions 224 of the second light-emitting element arrangement regions 220, and the predetermined chip positions 232 and repair chip positions 234 of the third light-emitting element arrangement regions 230 are arranged in a matrix. As shown in FIG. 2, the matrix includes columns C1, C2, C3, C4, C5, C6, C7, C8, C9, C10 and C11 and rows R1, R2, R3, R4, R5, R6, R7, R8, R9, and R10. In the following description, a position in the matrix is denoted as (X, Y), where X represents the column number and Y represents the row number. As shown in FIG. 2, in this embodiment, some positions of the matrix are empty, meaning that no bonding pads are provided for bonding light-emitting elements at those positions. For example, positions (C1, R1), (C2, R1), (C3, R1), (C1, R2), (C2, R2), (C3, R2) are empty. Similarly, positions (C9, R1), (C10, R1), (C11, R1), (C9, R2), (C10, R2), (C11, R2) are empty. Likewise, positions (C1, R5), (C2, R5), (C3, R5), (C1, R6), (C2, R6), (C3, R6) are empty. Similarly, positions (C9, R5), (C10, R5), (C11, R5), (C9, R6), (C10, R6), (C11, R6) are empty. Similarly, positions (C1, R9), (C2, R9), (C3, R9), (C1, R10), (C2, R10), (C3, R10) are empty. Similarly, positions (C9, R9), (C10, R9), (C11, R9), (C9, R10), (C10, R10), (C11, R10) are empty. Similarly, positions (C6, R3), (C6, R4), (C6, R7), and (C6, R8) are empty.

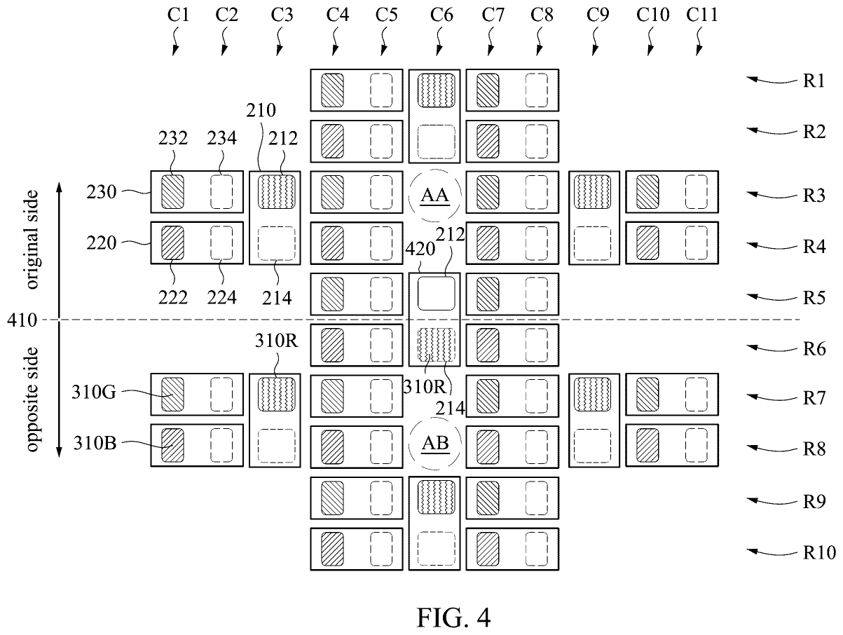

Referring to FIG. 4, FIG. 4 is a schematic diagram of a panel pixel structure according to an embodiment of the present disclosure. A micro LED in a repair region 420 is defective and therefore requires repair. In this embodiment, the repair region 420 corresponds to the first light-emitting element arrangement region 210, and the first light-emitting element 310R is disposed at the repair chip position 214 through an ex-situ repair process. As shown in FIG. 4, the first light-emitting element 310R in the repair region 420 serves as a repair light-emitting element and defines an original side and an opposite side in the matrix. The original side corresponds to a predetermined placement position of the first light-emitting element 310R (the predetermined chip position 212), and the opposite side corresponds to a repair position of the first light-emitting element 310R (the repair chip position 214). As shown FIG. 4, the original side and the opposite side are separated by a dividing line 410.

When all the first light-emitting elements 310R emit light at a predetermined brightness, since the first light-emitting element 310R in the repair region 420 has already been repaired at the repair chip position 214, the total brightness of the first light-emitting elements 310R on the original side becomes darker than expected, while the total brightness of the first light-emitting elements 310R on the opposite side becomes brighter than expected. Specifically, a region AA on the original side has a lower brightness, while a region AB on the opposite side has a higher brightness. Such brightness variation may cause the user to perceive a foreign-object sensation in the visual effect.

To address the above-mentioned foreign-object sensation issue, the embodiments of the present disclosure adjusts the brightness of the first light-emitting elements 310R on the original side and the brightness of the first light-emitting elements 310R on the opposite side, so that the brightness on the original side and the brightness on the opposite side can match the originally expected brightness, i.e., the brightness before repair.

Considering the first light-emitting elements 310R on the original side, since the total brightness of the first light-emitting elements 310R on the original side is lower, this embodiment controls the first light-emitting elements 310R adjacent to the repair region 420 on the original side to emit with a higher brightness. Specifically, the first light-emitting element 310R in the repair region 420 is located on the row R6, and the first light-emitting elements 310R closest to the row R6 on the original side are located on the row R3, for example, the two first light-emitting elements 310R at positions (C3, R3) and (C9, R3). Thus, the first light-emitting elements 310R on the row R3 are defined as brightness-enhanced light-emitting elements, which provide higher brightness during panel operation.

Considering the first light-emitting elements 310R on the opposite side, since the total brightness of the first light-emitting elements 310R on the opposite side is higher, this embodiment controls the first light-emitting elements 310R adjacent to the repair region 420 on the opposite side to emit with a lower brightness. Specifically, the first light-emitting element 310R in the repair region 420 is located on the row R6, and the first light-emitting elements 310R closest to the row R6 on the opposite side are located on the row R7, for example, the two first light-emitting elements 310R at positions (C3, R7) and (C9, R7). Thus, the first light-emitting elements 310R on the row R7 are defined as brightness-reduced light-emitting elements, which provides lower brightness during panel operation. In addition, the brightness of the first light-emitting element 310R in the repair region 420 (i.e., the repair light-emitting element) is also adjusted to provide lower brightness.

In summary, in the embodiment of the present disclosure, the display device of the embodiments of the present disclosure controls the brightness-enhanced light-emitting elements on a first adjacent row of the repair light-emitting element (the row R3 on the original side) to emit with a higher brightness, and controls the repair light-emitting element and the brightness-reduced light-emitting elements on a second adjacent row of the repair light-emitting element (the row R7 on the opposite side) to emit with a lower brightness. Specifically, the repair light-emitting element has a first brightness value, and the brightness-enhanced light-emitting elements have a second brightness value, and the brightness-reduced light-emitting elements have a third brightness value, in which the first and third brightness values are smaller than the second brightness value, and the first and third brightness values are different.

In some embodiments, considering the first light-emitting elements 310R, in addition to the repair light-emitting element, the brightness-enhanced light-emitting elements and the brightness-reduced light-emitting elements, other first light-emitting elements 310R, such as those located at positions (C6, R1) and (C6, R9), are defined as predetermined light-emitting elements which emit with a predetermined brightness. In other words, the embodiment of the present disclosure adjusts the brightness of the light-emitting elements closest to the repair light-emitting element, namely the brightness-enhanced light-emitting elements and the brightness-reduced light-emitting elements, and adjusts the brightness of the other light-emitting elements except for the repair light-emitting element, the brightness-enhanced light-emitting elements and the brightness-reduced light-emitting elements. The light-emitting elements farther from the repair light-emitting element (the predetermined light-emitting elements) are controlled to emit with the predetermined brightness. In other words, the embodiment of the present disclosure does not change the brightness of the light-emitting elements except for the repair light-emitting element, the brightness-enhanced light-emitting elements and the brightness-reducing light-emitting elements, in which the predetermined brightness is less than the aforementioned second brightness and greater than the aforementioned third brightness.

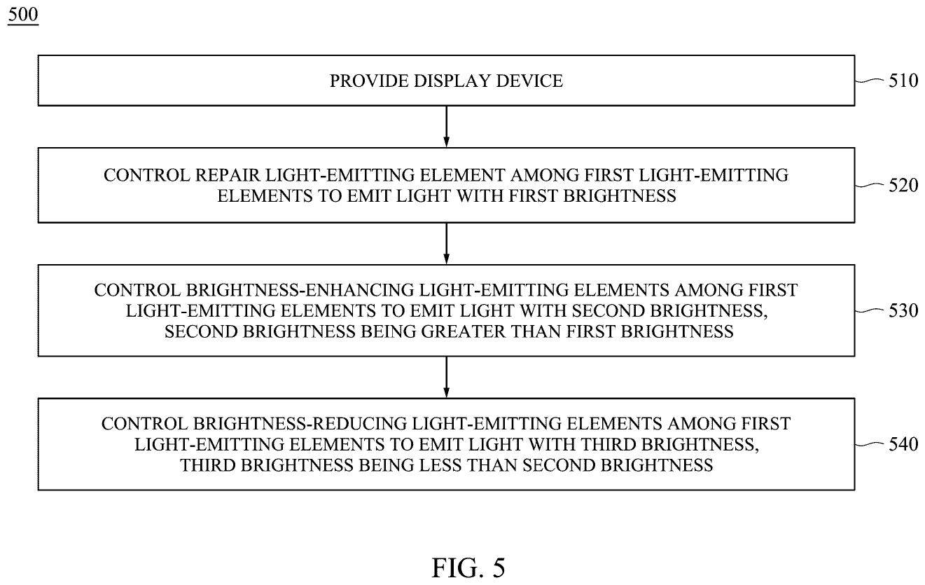

Referring to FIG. 5, FIG. 5 is a schematic flow diagram of a display method 500 according to an embodiment of the present disclosure. In step 510, the display device 100 described above is provided. In step 520, a repair light-emitting element is controlled to emit light with a first brightness. In step 530, brightness-enhanced light-emitting elements are controlled to emit light with a second brightness. In step 540, brightness-reduced light-emitting elements are controlled to emit light with a third brightness. In the embodiment of the present disclosure, the order of steps 520 to 540 may be varied. The embodiments of the present disclosure are not limited thereto.

In some embodiments, the display method 500 may further include controlling the predetermined light-emitting elements to emit with a predetermined brightness.

From the above description, it can be understood that the embodiment of the present disclosure controls the light-emitting elements on the original side and the opposite side and the repair light-emitting element to compensate for the brightness on the original side and the opposite side. Thus, the foreign-object sensation in the visual effect of the display device after repair can be eliminated.

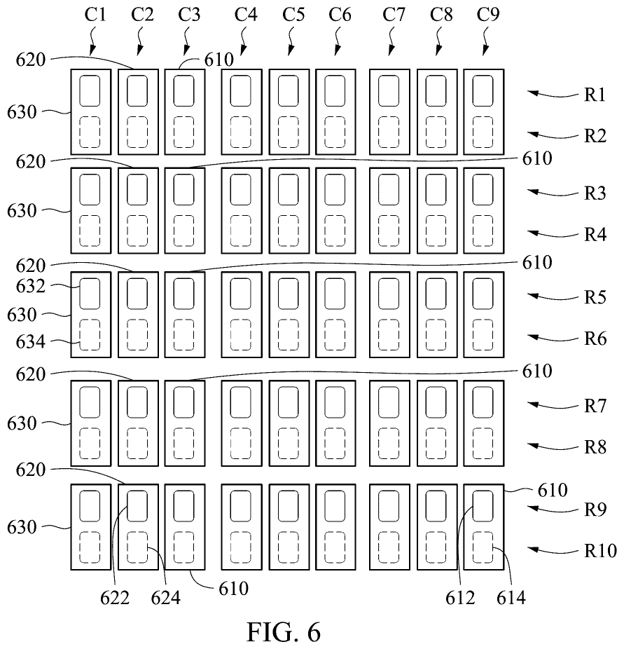

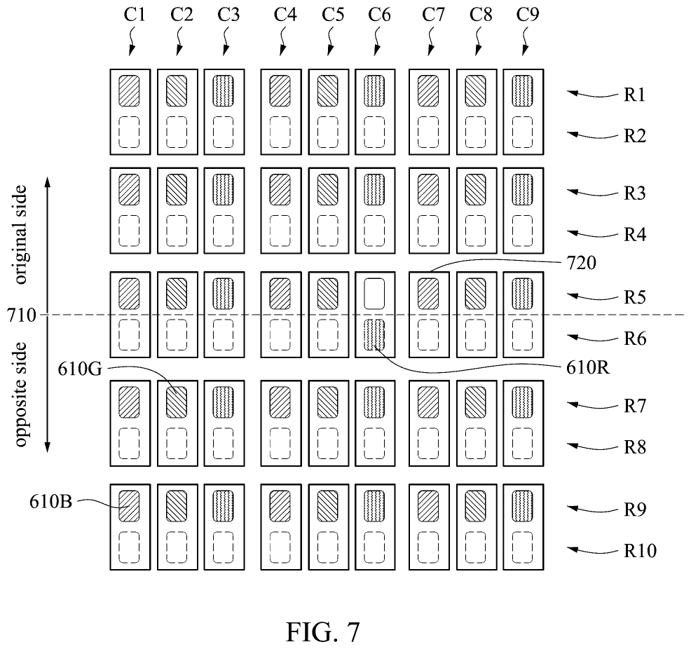

Referring to FIGS. 6 and 7, FIG. 6 is a schematic diagram of a panel pixel structure without light-emitting elements according to an embodiment of the present disclosure, and FIG. 7 is a schematic diagram of a panel pixel structure with light-emitting elements according to an embodiment of the present disclosure. The panel pixel structure shown in FIG. 7 has been repaired. The embodiments shown in FIGS. 6 and 7 are similar to those illustrated in FIGS. 2 and 4, except that FIGS. 6 and 7 correspond to a strip-type pixel structure. As shown in FIG. 6, first light-emitting element arrangement regions 610, second light-emitting element arrangement regions 620, and third light-emitting element arrangement regions 630 are arranged in a strip pattern.

The first light-emitting element arrangement regions 610 correspond to a first color, such as red. In other words, the first light-emitting element arrangement regions 610 are configured for red light-emitting elements, such as first light-emitting elements 610R (as shown in FIG. 7). The first light-emitting element arrangement region 610 includes a predetermined chip position 612 and a repair chip position 614 for placement of the first light-emitting element 610R. The second light-emitting element arrangement regions 620 correspond to a second color, such as green. In other words, the second light-emitting element arrangement regions 620 are configured for green light-emitting elements, such as second light-emitting elements 610G (as shown in FIG. 7). The second light-emitting element arrangement region 620 includes a predetermined chip position 622 and a repair chip position 624 for placement of the second light-emitting element 610G. The third light-emitting element arrangement regions 630 correspond to a third color, such as blue. In other words, the third light-emitting element arrangement regions 630 are configured for blue light-emitting elements, such as third light-emitting elements 610B (as shown in FIG. 7). The third light-emitting element arrangement region 630 includes a predetermined chip position 632 and a repair chip position 634 for placement of the third light-emitting element 610B.

In the embodiment of the present disclosure, the predetermined chip positions 612 and the repair chip positions 614 of the first light-emitting element arrangement regions 610, the predetermined chip positions 622 and the repair chip positions 624 of the second light-emitting element arrangement regions 620, and the predetermined chip positions 632 and the repair chip positions 634 of the third light-emitting element arrangement regions 630 are arranged in a matrix. As shown in FIG. 6, the matrix includes columns C1, C2, C3, C4, C5, C6, C7, C8 and C9 and rows R1, R2, R3, R4, R5, R6, R7, R8, R9, and R10.

As shown in FIG. 7, a micro LED in a repair region 720 is defective and therefore requires repair. In this embodiment, the repair region 720 corresponds to the first light-emitting element arrangement region 610, and the first light-emitting element 610R is disposed at the repair chip position 614 through an ex-situ repair process. The first light-emitting element 610R in the repair region 720 serves as a repair light-emitting element and defines an original side and an opposite side in the matrix. The original side corresponds to a predetermined placement position of the first light-emitting element 610R (the predetermined chip position 612), and the opposite side corresponds to a repair position of the first light-emitting element 610R (the repair chip position 614). As shown in FIG. 7, the original side and the opposite side are separated by a dividing line 710.

Considering the first light-emitting elements 610R on the original side, since the total brightness of the first light-emitting elements 610R on the original side is lower, this embodiment controls the first light-emitting elements 610R adjacent to the repair region 720 on the original side to emit with a higher brightness. Specifically, the first light-emitting element 610R in the repair region 720 is located on the row R6, and the first light-emitting elements 610R closest to the row R6 on the original side are located on the row R5, for example, the two first light-emitting elements 610R at positions (C3, R5) and (C9, R5). Thus, the first light-emitting elements 610R on the row R5 are defined as brightness-enhanced light-emitting elements, which provide higher brightness during panel operation.

Considering the first light-emitting elements 610R on the opposite side, since the total brightness of the first light-emitting elements 610R on the opposite side is higher, this embodiment controls the first light-emitting elements 610R adjacent to the repair region 720 on the opposite side to emit with a lower brightness. Specifically, the first light-emitting element 610R in the repair region 720 is located on the row R6, and the first light-emitting elements 610R closest to the row R6 on the opposite side are located on the row R7, for example, the three first light-emitting elements 610R at positions (C3, R7), (C6, R7), and (C9, R7). Thus, the first light-emitting elements 610R on the row R7 are defined as brightness-reduced light-emitting elements, which provide lower brightness during panel operation. In addition, the brightness of the repair light-emitting element 610R in the repair region 720 is also adjusted to provide lower brightness.

From the above description, it can be understood that the embodiments of the present disclosure provide different pixel structures to demonstrate that the embodiments can respectively control the light-emitting elements on the original side and the opposite side to compensate for brightness on the original side and the opposite side. Thus, the foreign-object sensation in the visual effect of the display device after repair can be eliminated.

Although the present disclosure has been described above with reference to several embodiments, these embodiments are not intended to limit the present disclosure. Any person having ordinary skill in the art may make various modifications and refinements without departing from the spirit and scope of the present disclosure. Therefore, the scope of protection of the present disclosure shall be defined by the appended claims.

What is claimed is:

1. A display device, comprising:
a plurality of first light-emitting element arrangement regions, corresponding to a first color, wherein the first light-emitting element arrangement regions includes a plurality of predetermined chip positions and a plurality of adjacent repair chip positions;
a plurality of second light-emitting element arrangement regions, corresponding to a second color, wherein the second light-emitting element arrangement regions includes a plurality of predetermined chip positions and a plurality of adjacent repair chip positions;
a plurality of third light-emitting element arrangement regions, corresponding to a third color, wherein the third light-emitting element arrangement regions includes a plurality of predetermined chip positions and a plurality of adjacent repair chip positions;
a plurality of first light-emitting elements, corresponding to the first color and disposed in the first light-emitting element arrangement regions;
a plurality of second light-emitting elements, corresponding to the second color and disposed in the second light-emitting element arrangement regions; and
a plurality of third light-emitting elements, corresponding to the third color and disposed in the third light-emitting element arrangement regions;
wherein the predetermined chip positions and the repair chip positions of the first, second, and third light-emitting element arrangement regions are arranged in a matrix manner;
wherein the first light-emitting elements includes a repair light-emitting element disposed at the repair chip position of one of the first light-emitting element arrangement regions and defining an original-side region and an opposite-side region in the matrix, and the predetermined chip position of the one of the first light-emitting element arrangement regions is located in the original-side region, and the repair chip position of the one of the first light-emitting element arrangement regions is located in the opposite-side region;
wherein the first light-emitting elements further comprises a plurality of brightness-enhancing light-emitting elements and a plurality of brightness-reducing light-emitting elements, and the repair light-emitting element is located on one row of the matrix, and the brightness-enhancing light-emitting elements are located on a first adjacent row of the matrix, and the brightness-reducing light-emitting elements are located on a second adjacent row of the matrix, and the first adjacent row is adjacent to the row of the matrix and located in the original-side region, and the second adjacent row is adjacent to the row of the matrix and located in the opposite-side region, and a brightness of the brightness-enhancing light-emitting elements is greater than that of the brightness-reducing light-emitting elements.

2. The display device of claim 1, wherein a brightness of the repair light-emitting element is less than that of the brightness-reducing light-emitting elements.

3. The display device of claim 1, wherein
the first light-emitting elements further comprises a plurality of predetermined light-emitting elements disposed on the first adjacent row and the second adjacent row; and
in the first and second adjacent rows, the brightness-enhancing light-emitting elements and the brightness-reducing light-emitting elements are those among the first light-emitting elements that are located closer to the repair light-emitting element, and the predetermined light-emitting elements are located farther from the repair light-emitting element.

4. The display device of claim 1, wherein the first color, the second color, and the third color are red, blue, and green, respectively.

5. The display device of claim 1, wherein the first light-emitting element arrangement region is larger than the second and third light-emitting element arrangement regions.

6. The display device of claim 1, wherein the first light-emitting elements, the second light-emitting elements and the third light-emitting elements are micro LEDs.

7. The display device of claim 1, further comprising a plurality of bonding pads located on the predetermined chip positions and the repair chip positions.

8. The display device of claim 1, wherein the first light-emitting elements, the second light-emitting elements and the third light-emitting elements are arranged to from a strip-type pixel structure.

9. A display method, comprising:
providing a display device, comprising
a plurality of first light-emitting elements, disposed in a plurality of first light-emitting element arrangement regions corresponding to a first color, the first light-emitting element arrangement regions including a plurality of predetermined chip positions and a plurality of adjacent repair chip positions;
a plurality of second light-emitting elements, disposed in a plurality of second light-emitting element arrangement regions corresponding to a second color; and
a plurality of third light-emitting elements, disposed in a plurality of third light-emitting element arrangement regions corresponding to a third color, wherein the first, second, and third light-emitting elements are arranged in a matrix manner;
controlling a repair light-emitting element among the first light-emitting elements to emit light with a first brightness, wherein the repair light-emitting element is disposed at a repair chip position of one of the first light-emitting element arrangement regions and defines an original-side region and an opposite-side region in the matrix, and a predetermined chip position of the one of the first light-emitting element arrangement regions is located in the original-side region, and the repair chip position of the one of the first light-emitting element arrangement regions is located in the opposite-side region;
controlling a plurality of brightness-enhancing light-emitting elements among the first light-emitting elements to emit light with a second brightness, wherein the repair light-emitting element is located on one row of the matrix, and the brightness-enhancing light-emitting elements are located on a first adjacent row of the matrix, and the first adjacent row is adjacent to the row of the matrix and located in the original-side region, and the second brightness is greater than the first brightness; and
controlling a plurality of brightness-reducing light-emitting elements among the first light-emitting elements to emit light with a third brightness, wherein the brightness-reducing light-emitting elements are located on a second adjacent row of the matrix, and the second adjacent row is adjacent to the row of the matrix and located in the opposite-side region, and the third brightness is less than the second brightness.

10. The display method of claim 9, wherein the first brightness is less than the third brightness.

11. The display method of claim 9, wherein
the first light-emitting elements further comprises a plurality of predetermined light-emitting elements disposed on the first adjacent row and the second adjacent row;
in the first and second adjacent rows, the brightness-enhancing light-emitting elements and the brightness-reducing light-emitting elements are those among the first light-emitting elements that are located closer to the repair light-emitting element, and the predetermined light-emitting elements are located farther from the repair light-emitting element; and
the display method further comprises:
controlling the predetermined light-emitting elements to emit light with a predetermined brightness, the predetermined brightness being smaller than the second brightness and greater than the third brightness.

12. The display method of claim 9, wherein the first color, the second color, and the third color are red, blue, and green, respectively.

13. The display method of claim 9, wherein the first light-emitting element arrangement region is larger than the second and third light-emitting element arrangement regions.

14. The display method of claim 9, wherein the first light-emitting elements, the second light-emitting elements and the third light-emitting elements are micro LEDs.

15. The display method of claim 9, wherein the first light-emitting elements, the second light-emitting elements and the third light-emitting elements are arranged to from a strip-type pixel structure.
